(19) United States
(12) Patent Application Publication
(10) Pub. No.: US 2019/0251523 A1
(43) Pub. Date: Aug. 15, 2019

(54) SYSTEMS AND METHODS OF CONVERTING ELECTRONIC TRANSMISSIONS INTO DIGITAL CURRENCY

(71) Applicant: Gopher Protocol Inc., Santa Monica, CA (US)

(72) Inventors: Danny Rittman, San Diego, CA (US); Aliza Schnapp, Beverly Hills, CA (US)

(21) Appl. No.: 16/008,069

(22) Filed: Jun. 14, 2018

Related U.S. Application Data
(60) Provisional application No. 62/631,007, filed on Feb. 15, 2018.

(51) Int. Cl. G06Q 20/06; G06F 21/57

(52) U.S. Cl. CPC G06Q 20/065; G06F 21/572

(57) ABSTRACT

Systems and methods for generating digital currencies and converting electronic transmissions from a communication device into digital currency are provided. A communication device comprises an electronic circuit including a controller, a secured basic input/output (BIOS) system, a memory unit, a radio unit, and an antenna. The radio unit and the antenna generate periodic transmissions. The communication device communicates with a network comprising a blockchain. The electronic circuit counts the periodic transmissions and creates a digital coin when a pre-determined number of transmissions is generated. Transmission data corresponding to the digital coin are encrypted and stored in the blockchain. A user can use the digital coin to purchase goods or services or to exchange with another currency. The communication device may be a personal computing device or a tracking device for global tracking of objects wherein an electronic circuit is embedded within a patch package comprised of a flexible material.

### CROSS-REFERENCE TO RELATED APPLICATION

This application is a non-provisional of and claims priority to U.S. Patent Application No. 62/631,007, filed Feb. 15, 2018, which is hereby incorporated by reference in its entirety.

### FIELD

The present disclosure relates to digital currencies and converting electronic transmissions into digital currencies.

### BACKGROUND

In the very early days people exchanged value via a barter system of trading goods followed by the development of commodity money (i.e. silver and gold coins) as they were easy to carry and divide and had a level of scarcity that provided value. With the rise of banking arose a debt-based system where we deposited gold with the bank and they issued us a piece of paper representing how much gold we had with the bank. After all, it is much easier to carry around paper bills than a bag of gold.

A notable recent development in the monetary system is digital currency. A digital currency is a medium of exchange that is generated, stored and transferred electronically. Digital currencies are not typically associated with any country's government or represented in physical forms like the coins and notes of traditional currencies. Cryptocurrency is the most common type of digital currency. Cryptocurrencies rely on encryption to secure the processes involved in generating units and conducting transactions. They are used similarly to conventional money for purchases online. The first widely-adopted cryptocurrency, Bitcoin, relies on blockchain's distributed ledger model to prevent a single point of failure and to ensure that the record of transactions is tamper-proof.

Most other well-known cryptocurrencies also use blockchain, and the technology is being explored in many industries as a secure and cost-effective way to create and manage a distributed database and maintain records for digital transactions of all types. Virtual currencies, another subset of digital currencies, are mediums of monetary exchange that are confined to particular software-based environments. One of the earliest virtual currencies was the Linden dollar of Second Life.

There is tremendous interest in the cryptocurrency space right now and the interest in this field is rapidly growing. There has been plenty of hype amongst banks and businesses about the promises of the underlying technology which is blockchain based, but not Bitcoin itself. This represents firms building “private blockchains currencies” similar to the narrative in the early days of the internet of private intranets vs. the public internet.

The natural response to these concepts often is skepticism and rejection, but beneath the jargon lies a powerful new technology revamping our financial system. Bitcoin started as an experiment in the depths of the global Financial Crisis of 2008 aiming to build a better financial system. Bitcoin being digital in and of itself is not entirely revolutionary as the vast majority of the wealth in the world is already digital. When we check our bank account balances online we don't actually have that amount of physical money sitting in a bank vault. Money is simply an accounting system. The bank runs its own private internal ledger (accounting mechanism) that keeps track of all the ones and zeros in the system (account balances).

Early on, cryptocurrencies developed a seedy undertone as they were mainly associated with black market trades: drug deals, ransomware payments, money laundering and tax evasion. Cryptocurrency has been described as the most disruptive technology since the internet as well as a fraud or a massive Ponzi scheme. We live in a digital era where the new generation prefers to trust the “abstract,” question traditional norms and find a better way forward through technology. Digital currency brings a multifunctional financial utility to the world by creating an open financial system and allowing us to store and transact value in ways that we never thought imaginable before.

Accordingly, there exists a need for a new type of digital currency that provides a secure means of conducting financial transactions. There is a need for a digital coin that can be securely encrypted and stored so it cannot be hacked, stolen or seized. There is also a need for a digital coin that has a traceable digital history. Finally, there is a need for a digital currency that provides people with both security and full proprietorship.

### SUMMARY

The present disclosure, in its many embodiments, alleviates to a great extent the disadvantages of known digital currencies by providing a systems and methods whereby an electronic circuit generates electronic and/or radio transmissions and has the ability to generate a digital coin when a pre-determined number of transmissions is generated. The transmission data corresponding to the digital coin are encrypted and stored in a proprietary blockchain. Each digital coin has a unique and verifiable digital history. In exemplary embodiments, the coin wallet system will be built around a safe-cold storage compatible interface that can also be pulled up and accessed from any electronic device.

To be known as Gopher Radio Coin, or GRC, this new form of digital currency is a new concept of cryptocurrency. The GRC introduces a new, private, secured digital currency that is enclosed within Gopher Protocol's Blockchain. It is a new type of digital money to be used by Gopher's customers and members. This digital money is not issued or controlled by anyone. Instead, it is generated by each Gopher Protocol communication device transmission that can also be used to mine the coins in a distributed ledger technology. GRC is offering a breakthrough method to exchange currency.

Users can use the GRC between system members to buy goods or currency exchange for any purpose or to buy goods and services outside the system, store wealth, or send value to anyone within Gopher system building the coin to be traded against all major fiat currencies. GRC is stored properly and completed encrypted not to be hacked, stolen or seized. GRC gives people full proprietorship much like having a Swiss bank account in their pocket. Unlike physical money, GRC is cheaper, faster, appreciates in value by its limited supply-non-inflationary nature, allowing its users to profit while transacting with the coin and more efficient to store or send anywhere in the Gopher network, worldwide.

Exemplary embodiments of include a communication device comprising an electronic circuit including a controller, a secured basic input/output (BIOS) system, a memory unit, a radio unit, and an antenna. The radio unit and the antenna generate periodic transmissions. The electronic circuit counts the periodic transmissions and generates a digital coin when a pre-determined number of transmissions is reached. In exemplary embodiments, the transmissions are recorded as a data packet and stored in the digital coin's blockchain.

In exemplary embodiments, the transmissions stored in the digital coin will be encrypted and stored in its own blockchain as a digital history of the digital coin. In exemplary embodiments, the electronic circuit creates a unique PIN code corresponding to each periodic transmission. A user can use the digital coin to purchase goods or services or to exchange with another currency. In exemplary embodiments, the communication device is a personal computing device. In exemplary embodiments, the communication device is a tracking device and the electronic circuit is embedded within a patch package comprised of a flexible material.

Exemplary embodiments of systems for converting electronic transmissions into digital currency comprise at least one communication device comprising an electronic circuit including a controller, a secured basic input/output (BIOS) system, a memory unit, a radio unit, and an antenna, and a network comprising a blockchain. The radio unit and the antenna generate periodic transmissions. The electronic circuit counts the periodic transmissions and creates a digital coin when a pre-determined number of transmissions is generated. Transmission data corresponding to the digital coin are encrypted and stored in the system's proprietor blockchain blockchain. The blockchain may be distributed across the network as well as internet platforms.

In exemplary embodiments, at least one communication device comprises multiple communication devices corresponding to multiple users. Each user can use one or more digital coins to purchase goods or services or to exchange with another currency that could be fiat currency or cryptocurrency. Each user can use one or more digital coins to transfer any monetary value to the Gopher Blockchain.

In exemplary embodiments, the transmission data is updated and when a second pre-determined number of transmissions is generated, a second GRC coin is generated. The transmission data may be sliced into segments and stored in the blockchain. In exemplary embodiments, a reconstruction key is stored on the communication device, the reconstruction key capable of unencrypting the transmission data.

Exemplary methods of converting electronic transmissions into digital currency comprise generating periodic transmissions from a communication device, counting the periodic transmissions. Creating a digital coin when a pre-determined number of periodic transmissions is generated and encrypting transmission data corresponding to the digital coin and storing the transmission data in the system's proprietary blockchain. Exemplary methods may further comprise distributing the blockchain across the network. The transmission data may be updated and the system's digital coin created when a second pre-determined number of transmissions is generated. Exemplary embodiments further comprise slicing the transmission data into segments and storing it in the system's proprietary blockchain Exemplary methods further comprise calculating a geographical location of the communication device.

Accordingly, it is seen that digital currencies, communication devices, and systems and methods of converting electronic transmissions into digital currencies are provided. These and other features of the disclosed embodiments will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a perspective view of an exemplary embodiment of a system for converting electronic transmissions into digital currency in accordance with the present disclosure;

FIG. 2A is a schematic of an exemplary embodiment of a decentralized network in accordance with the present disclosure;

FIG. 2B is a schematic of an exemplary embodiment of a centralized network in accordance with the present disclosure;

FIG. 2C is a schematic of an exemplary embodiment of a distributed network with anonymous users in accordance with the present disclosure;

FIG. 2D is a schematic of an exemplary embodiment of a distributed network with non-anonymous users in accordance with the present disclosure;

FIG. 3A is a schematic of an exemplary embodiment of a blockchain in accordance with the present disclosure;

FIG. 3B is a schematic of an exemplary embodiment of a blockchain in accordance with the present disclosure;

FIG. 4 is a schematic of an exemplary embodiment of a system for converting electronic transmissions into digital currency in accordance with the present disclosure;

FIG. 5 a schematic of an exemplary embodiment of an electronic circuit in accordance with the present disclosure;

FIG. 6 is an exploded view of an exemplary embodiment of a tracking device in accordance with the present disclosure;

FIG. 7 is a perspective view of an exemplary embodiment of a tracking device in accordance with the present disclosure;

FIG. 8 is a perspective view of an exemplary embodiment of a tracking device in accordance with the present disclosure;

FIG. 9 is a perspective view of an exemplary embodiment of an affix sensor in accordance with the present disclosure;

FIG. 10 is a process flow diagram illustrating an exemplary embodiment of a method of converting electronic transmissions into digital currency in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure.

As used herein, the “present disclosure” refers to any one of the embodiments described herein, and any equivalents. Furthermore, reference to various aspects of the disclosure throughout this document does not mean that all claimed embodiments or methods must include the referenced aspects. Reference to materials, configurations, directions, and other parameters should be considered as representative and illustrative of the capabilities of exemplary embodiments, and embodiments can operate with a wide variety of such parameters. It should be noted that the figures do not show every piece of equipment, nor the materials, configurations, and directions of the various circuits and communications systems.

Disclosed embodiments comprise communication devices like tracking systems, microchip-based devices, and could include any type of personal computing device such as a smartphone, tablet, etc. At a high level, exemplary embodiments work as follows. Each device type is transmitting a signal at a certain time interval. These transmissions are counted and recorded to be used to securely store and create an amount of value. The value is stored in the user's account anywhere in the world. Exemplary devices, systems, and methods create radio-based tokens from the devices' radio transmissions, users collect these digital coins, based on their system usage, and users can use the coins to buy or sell goods and services, send money to people or organizations, or even extend credit.

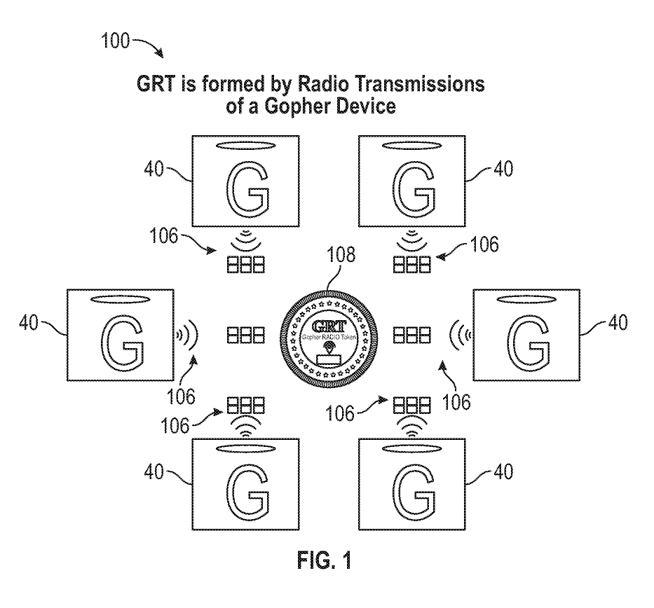

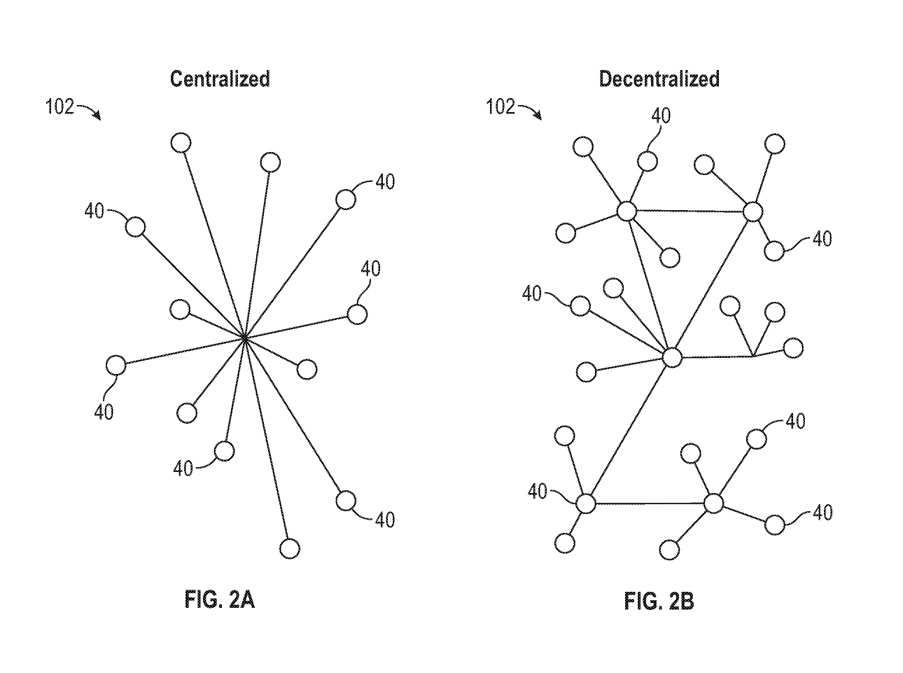

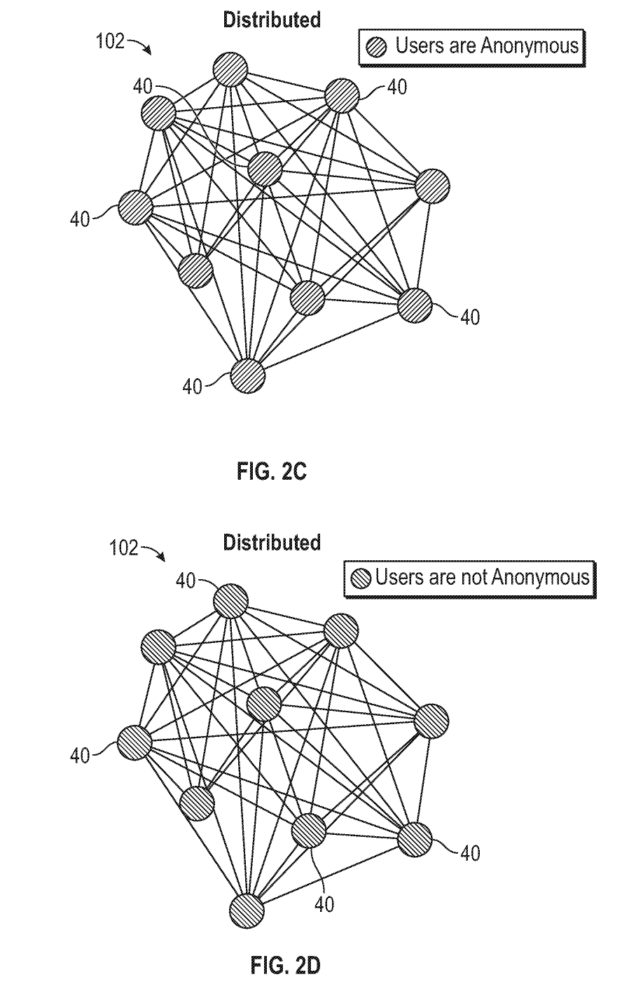

FIGS. 1-4 show an overview of an exemplary embodiment of a system that creates digital currency. More particularly, system 100 converts electronic transmissions into digital currency. System 100 may be comprised of a network 102 including a blockchain 104 and one or more communication devices 40. The network 102 could be centralized (FIG. 2A) or decentralized (FIG. 2B) and could distributed where users are anonymous (FIG. 2C) or distributed where users are not anonymous (FIG. 2D). The communication device could be one or more of a personal computer, a smartphone, a tablet computer, a tracking device, a PDM, a server, a cloud server array, a blade, a cluster, a supercomputer, a supercomputer array, and a game machine, and/or any other device with computing functionality. As discussed in detail below, each communication device 40 contains at least one electronic circuit 10, and the electronic circuit includes basic systems and components such as a secured basic input/output (BIOS) system, a memory unit, a radio unit, and an antenna. In exemplary embodiments, the electronic circuit also has specialized systems and components such as a public and private unit for security purposes.

Via the radio unit and antenna, the communication device 40 emits periodic transmissions 106. Each transmission 106 is associated with the account of the user, i.e., the owner of the communication device. The electronic circuit 10 counts the periodic transmissions, and one digital coin 108 is formed when a certain pre-determined number of transmissions 106 is generated. The transmission data corresponding to the digital coin 108 are stored. More particularly, each set of transmissions is recorded as a data packet and stored within the digital coin and/or in the blockchain. In this way a complete audit trail is recorded for each coin, and this becomes the coin's digital history. In exemplary embodiments, the transmissions are encrypted using an advanced security algorithm to ensure maximum security.

Users collect digital coins based on their system usage. For example, a mobile unit or communication device 40 may emit a location transmission every 10 minutes. Each transmission is encrypted using a mathematical algorithm and stored on the system's network history. The transmission is sliced into millions of data segments, and each segment is stored on the network, worldwide. After a certain amount of transmissions, a radio token coin 108 is formed for the user's credit. In exemplary embodiments, the radio token coin 108 is divisible to the ten-decimal place and is completely digital, allowing the transfer of any monetary value.

In exemplary embodiments, the system is constructed by electronic circuitry (Hardware) that works in conjunction with AI based software. The hardware creates a PIN code (Similar to VIN number) that is different for each device transmission. The software is processes the overall transmitted information that is constructed of date, time, GEO location coordinates, device ID and other proprietary data. The information is then mathematically encrypted and stored as one transaction in the user's account on the network. In addition, a backup copy may be stored on the system's servers. After a certain number of transactions of this type, a radio based digital coin is formed. Each digital coin has all of its history attached to it for possible future history checks. This is done to eliminate the creations of fake radio coins by malicious hackers or robots.

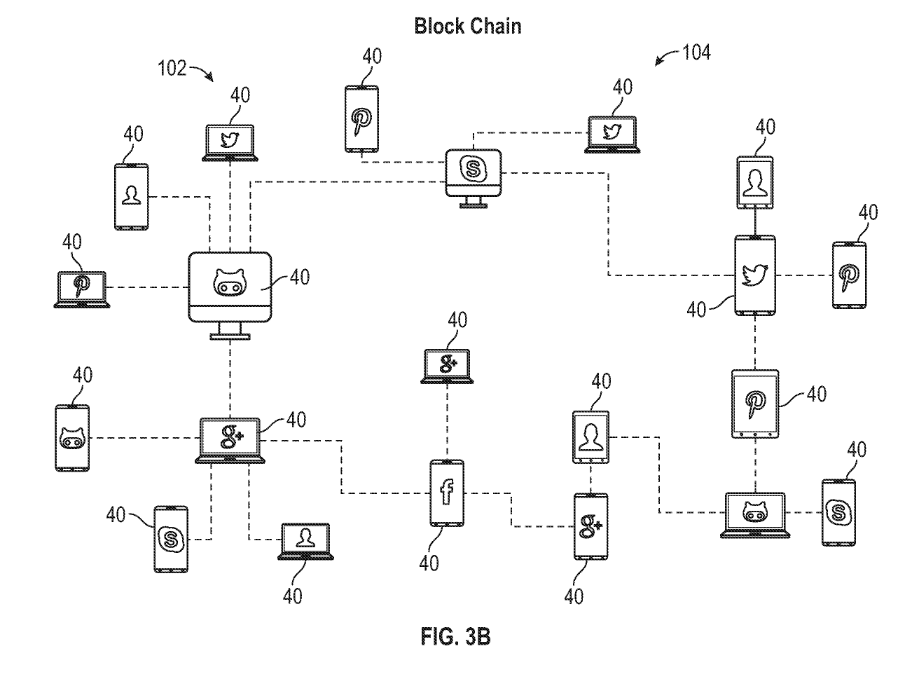

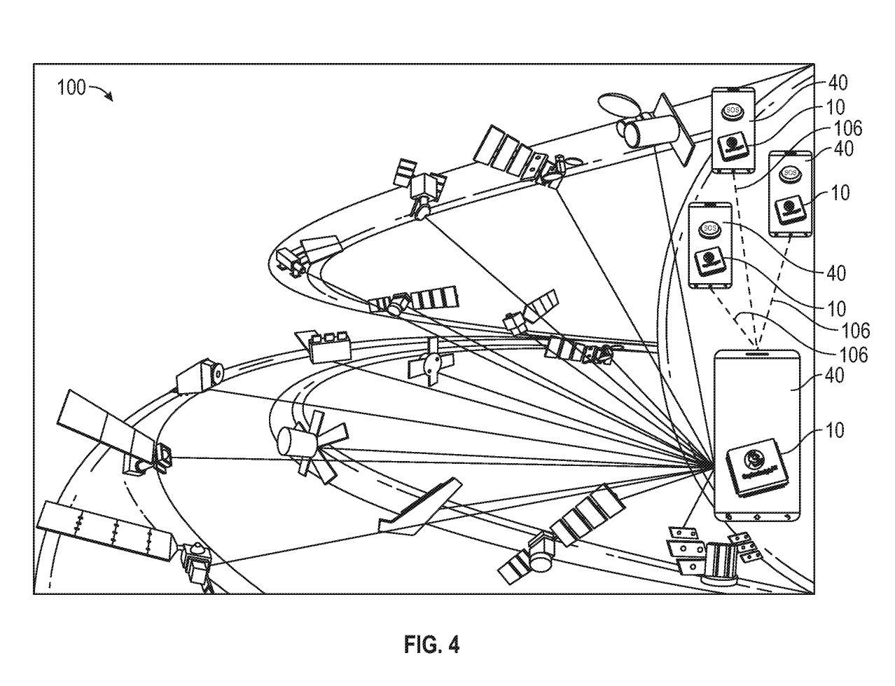

As discussed above, exemplary systems and methods include one or more communication devices. Turning to FIGS. 5 and 6, an exemplary communication device will now be described. A communication device 40 comprises an electronic circuit 10. Any type of electronic circuit or microchip could be used and configured as described herein, including but not limited to, a low noise amplifier (LNA) type circuit, a customized voltage-controlled oscillator (VCO) type circuit, a phase locked loop (PLL) type circuit, a low pass filter (LPF) type circuit, a notch filter type circuit, and/or a serializer and de-serializer (SERDES) type circuit. Proprietary electronic circuits are described in co-pending application Ser. No. 15/015,441, filed Feb. 4, 2016, which is hereby incorporated by reference in its entirety.

Referring to FIG. 5, an exemplary electronic circuit 10 comprises a process subsystem 12 including a compliance circuit 13, a microprocessor 15, an interrupt controller 17, and a bridge 19. The electronic circuit 10 further comprises a control block 37 including a clock manager 39, a reset manager 41, a power manager 43, and a system control 45. The electronic circuit also has a cryto-block 14 including a master sub-block 51, a slave sub-block 53, a direct memory access circuit 55, a packet buffer 57, and one or more crypto-engines 59.

An interconnect 61 communicatively connects the process subsystem 12 to the control block 37 and the crypto-block 14. The interconnect circuit 61 serves as a general interface to the various sub-blocks of the electronic circuit 10. The electronic circuit 10 may include one or more network connections that can communicatively connect the electronic circuit to a public network of computers, which could be linked by the internet. One of the network connections can communicatively connect the electronic circuit 10 to a private network of computers, separate and distinct from the public network. The electronic circuit 10 may include a memory unit/controller 31 comprised of a memory controller circuit. An external memory interface 33 may be in communication with the memory unit 31 via a memory interface port. In exemplary embodiments, the electronic circuit 10 may further comprise a radio unit 83 and an antenna 19 embedded within the electronic circuit and/or located outside the electronic circuit and communicatively connected to the electronic circuit.

Exemplary electronic circuit architecture may be arranged to have some forms of a public unit and a private unit. A barrier may be located between the public unit and the private unit. The public unit may include a network connection that can communicatively connect the electronic circuit 10 to a public network of computers, which could be linked by the internet. A second network connection may be located within the private unit. The second network connection can communicatively connect the electronic circuit 10 to a private network of computers, separate and distinct from the public network. The network connections can be wireless or wired connections. For additional security, the second network connection may be a wired connection to the private network, and the private unit may also be configured so it cannot connect to the internet. In exemplary embodiments, the private unit is not connected to the internet and the public unit is connected to the internet.

A barrier may be located between the public and private units, sub-blocks, or groups of sub-blocks. It should be noted that the barrier is not necessarily located physically between the two units, sub-blocks, or groups of sub-blocks; rather, it stands between them for communication purposes, separating the private unit from the public unit for security while at appropriate times serving as an interconnect to communicatively connect the two units. The barrier may also separate the first and second network connections. More particularly, the barrier may be an inner hardware-based access barrier or inner hardware-based firewall. An exemplary barrier has a signal interruption mechanism to prevent communications between the private and public units, sub-blocks, or groups of sub-blocks when necessary or desirable. In exemplary embodiments, the signal interruption mechanism is a bus having an on/off switch that controls communication input and output.

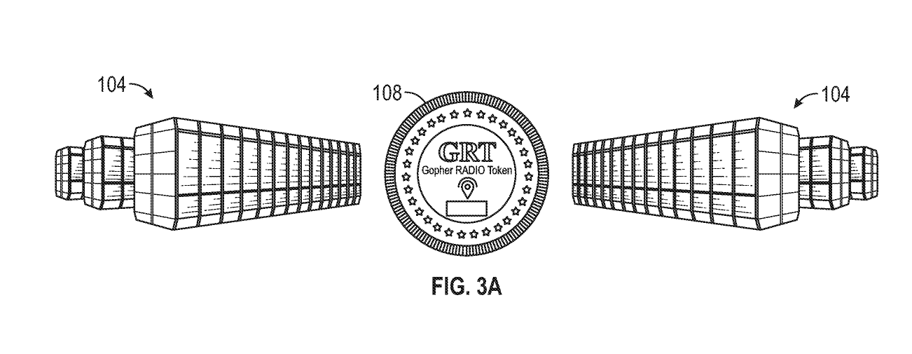

Returning to FIG. 4, in exemplary embodiments an electronic circuit 10 forms an integral part of a communications system 100 comprising one or more personal computing devices 40. In exemplary systems, each personal computing device 40 houses an electronic circuit 10. More particularly, the electronic circuit or microchip 10 can be embedded within a mobile device's existing microchip or installed within a mobile device's electronic board, as an integral part of the system, and be configured to operate as a specific purpose electronic circuit or microchip. Alternatively, the electronic circuit or microchip 10 could be part of a complete, independent computer system within a mobile device. In FIG. 4, satellite communications are represented by solid lines and electronic circuit transmissions 106 by dashed lines.

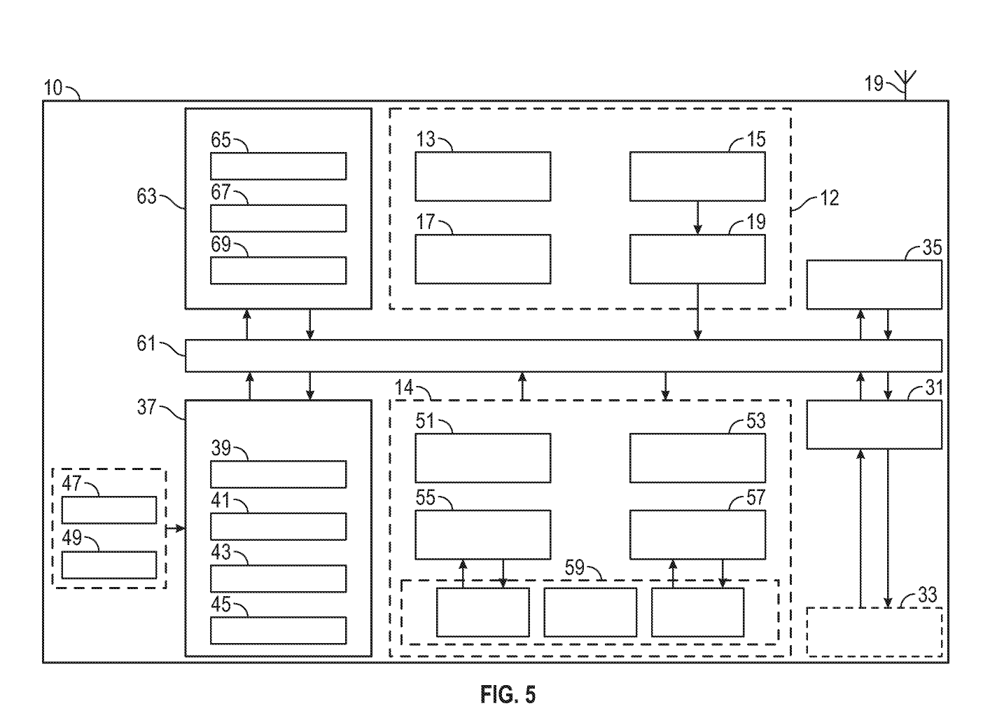

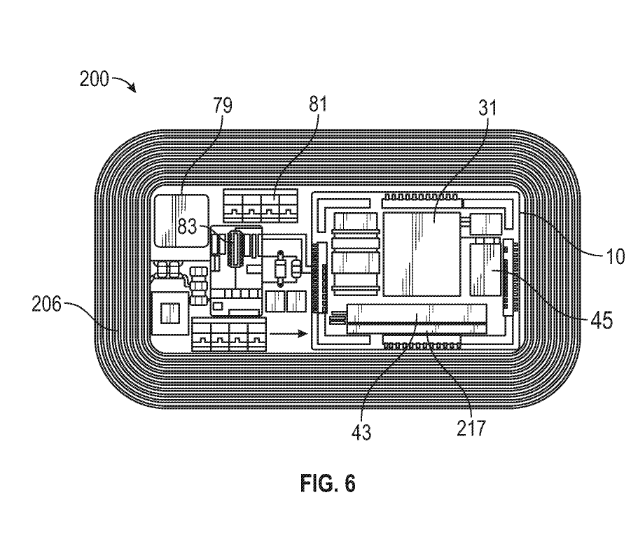

In exemplary embodiments, the communication device is a tracking device. For With reference to FIGS. 6-8, exemplary embodiments of a tracking device 200 comprise a package 202 with an electronic circuit 10 embedded therein. The package 202, also referred to as a “patch” or patch package, may be made of or coated with a sticky material so its outer surface is sticky. The patch package 202 is made of a flexible and lightweight but rugged material such as a polymer-based or plastic material or any other material that provides both flexibility and strength. In exemplary embodiments, the patch package 202 is made of a material that is waterproof and otherwise weatherproof so it is not damaged in inclement weather and protects the electronic circuit 10 and other electronics contained in the device 200.

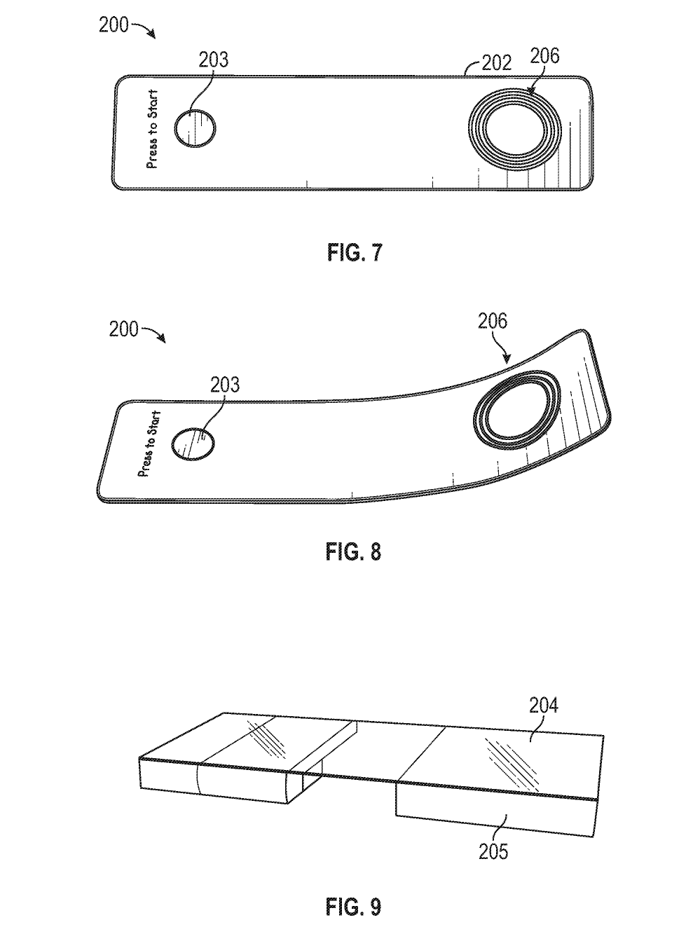

The stickiness of the package 202 advantageously serves to enable the tracking device 200 to be affixed to an object as a patch product which can track the object anywhere. As described in more detail herein, when activated by pressing the start button 203, the electronic circuit 10 within the tracking device 200 transmits signals to enable tracking of the device's location anywhere on Earth. As best seen in FIG. 9, an affix sensor 204 may be provided with the tracking device 200. The affix sensor 204 is an advanced circuitry including an affix circuit 217 that controls the device's mounting and removal responses and may be integrated with the electronic circuit 10 or a separate component in communication with the electronic circuit 10.

Advantageously, the affix sensor 204 determines whether the tracking device 200 is affixed to the object to be tracked, and in exemplary embodiments the tracking device automatically turns on when affixed to an object. In exemplary embodiments, the “peel-and-stick” sensor system includes an adhesive 205 to stick to an object and pressure sensors 211 and conductivity sensors that detect application to the object and start the device's operation. It will stay on that object for the rest of the device's life and, once attached to an object, an internal clock starts to work. The clock has several tasks, one of which is determining the device's lifetime. Advantageously, the affix sensor can also determine if the device 200 gets removed from the object.

As shown in FIG. 6, the tracking device 200 also includes an antenna 206 to facilitate communications. More particularly, the tracking device 200 may include an antenna 206 and control circuitry configured to control transmission and receipt of broadband information to and from the antenna 206. Antenna 206 may be integrated with the electronic circuit 10 or be a separate component in communication with the electronic circuit 10. The antenna may be any form or type of antenna such as a wire antenna 206 or a ball antenna. The ball-based structure advantageously provides more power in a miniature antenna structure for use with various wave lengths in smaller scales.

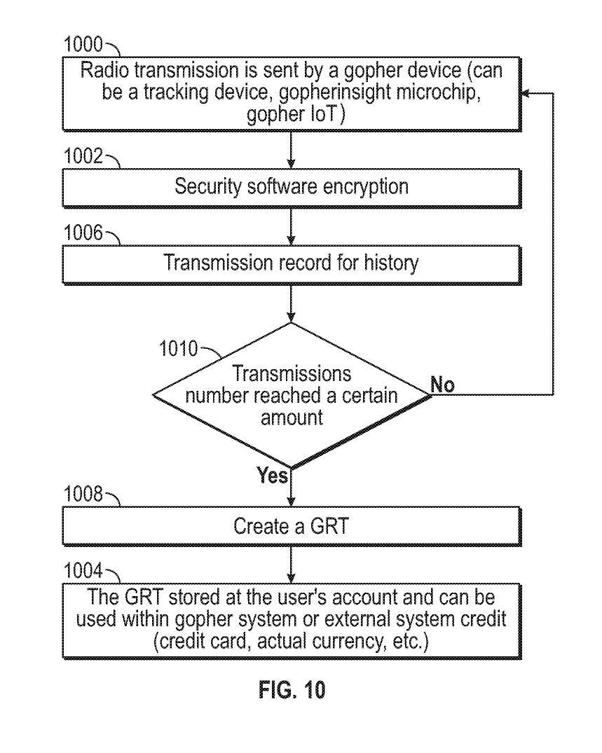

In operation, as illustrated by the exemplary flow diagram in FIG. 10, the electronic transmissions are sent from a communication device (Step 1000) and converted into digital currency (Step 1008) when a pre-determined number of periodic transmissions from the radio unit and antenna are generated and counted (Step 1010). The transmission data corresponding to each digital coin generated is encrypted (Step 1002) and stored in the user's account (Step 1004). In exemplary embodiments, that data, which constitutes a verifiable digital history or record of each coin is maintained (Step 1006) and may be distributed throughout the system's network. The network is a peer-to-peer network that runs on a decentralized distributed self-clearing ledger called the blockchain. A blockchain is a tamper-proof, encrypted database secured by cryptography that acts as an accounting ledger keeping track of digital assets. Instead of being maintained by a single server like traditional databases, blockchains are decentralized and maintained by a distributed network of computers around the world.

Units of currency that run on the network are the radio digital coins. The digital coins are stored and transmit value among network participants. Unlike most currencies issued by central banks, which can be devalued and manipulated, in disclosed systems and methods digital coins are issued according to a fixed set of rules to create digital money that can't be manipulated by a central authority. Users can use the digital currency to buy or sell goods and services, send money to people or organizations, or even extend credit in a fast, secure and borderless manner.

The only prerequisite for access to these coins is that they are generated by using the proprietary system's radio-based communication devices. Each radio-based device's transmissions are encrypted and stored on the network. A full history data packet is enclosed with each digital coin for audit trail purposes. Unauthorized access to someone's radio token is analogous to stealing gold from their vault and can be traced using the coin's history, i.e., its audit trail data.

The radio digital coin is decentralized from its inception. This means that there is no central entity or one person with control over it. Each radio digital coin comes with its own history of creation (i.e., number of radio transmissions and their history). Each coin is kept within the proprietary system and belongs to its owner. In addition, the digital coin is fully distributed. This means that instead of one central server owned and operated by a singular entity, the ledger is distributed across the global network making it impossible to shut down as there is no central point of failure. There is no single address or location for someone to raid; there is no central server to hack.

In exemplary embodiments, the data for each digital coin is spliced to millions of segments and stored in user's devices, through the system's network, worldwide. This is a true meaning of blockchain-based coin. The database system tracks every digital coin in the network and each transaction from the moment the very first coin is created. The database is maintained by the users, transparently. Each user's system is used to store encrypted digital coin data splices. The system maintains backup data slices to maintain sufficient redundancy to ensure the digital currency's availability to their owners. Each system user is an immediate miner who will be able to profit from the mining activity while using the devices to generate coins at the same time and appreciate the value of the coins by their limited-supply-nature. One can think of the radio token system as an accounting system. Through the blockchain and its storing system, it is a way of recording transactions and value digitally in an open and distributed self-clearing ledger.

It should be noted that the disclosed digital currency methodology advantageously operates a set of rules that is technology based. More particularly, because the coin is radio based, it is created according to a strict RF set of rules, which are embedded within the operational flow, illustrated in FIG. 10, and includes encryption and internal circuitry. Such rules include, but are not limited to: each communication device's transmission is encrypted using a proprietary algorithm; the transmission data is added to previous, past transmissions; all transmissions are recorded as an encrypted data packet for audit trail; when a certain number of transmissions are reached and after mathematical based encryption, the data forms a radio digital coin; the coin data, with its history, is sliced into segments and stored on the network, worldwide; the reconstruction key goes through another encryption and is stored on the user's device; a backup of the slices and key are stored on the network for redundancy; each user can accumulate more coins simply by using the communication devices; users can use their coins only within the proprietary system; the digital coins can be used among network members; digital coins can be used to purchase items outside the network using an outsourcing system.

Until now the only way to operate such a system was through the rules of the government. Now GRC is governed in a decentralized way through the agreement of the above-listed fixed set of technological rules. For the same reasons as the internet, the real value of the disclosed embodiments will be for the system's user. It offers open global currency access as its operating in a close, private system. Disclosed embodiments offer an entire parallel system of finance rather than using the typical banking technology. In sum, GRC offers a new, revolutionary cryptocurrency system that is enclosed within a group of members and ensuring security and flexibility.

Thus, it is seen that digital currencies, communication devices, and systems and methods of converting electronic transmissions into digital currencies are provided. It should be understood that any of the foregoing configurations and specialized components or connections may be interchangeably used with any of the systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the present disclosure.

What is claimed is:

1. A communication device comprising:
an electronic circuit including a controller, a secured basic input/output (BIOS) system, a memory unit, a radio unit, and an antenna;
wherein the radio unit and the antenna generate periodic transmissions;
wherein the electronic circuit counts the periodic transmissions and creates a digital coin when a pre-determined number of transmissions is generated.

2. The communication device of claim 1 wherein the transmissions are recorded as a data packet and stored in the digital coin.

3. The communication device of claim 2 wherein the transmissions stored in the digital coin are encrypted and stored in a network as a digital history of the digital coin.

4. The communication device of claim 1 wherein the electronic circuit creates a unique PIN code corresponding to each periodic transmission.

5. The communication device of claim 2 wherein a user can use the digital coin to purchase goods or services or to exchange with another currency.

6. The communication device of claim 1 wherein the communication device is a personal computing device.

7. The communication device of claim 1 wherein the communication device is a tracking device and the electronic circuit is embedded within a patch package comprised of a flexible material.

8. A system for converting electronic transmissions into digital currency, comprising:
at least one communication device comprising an electronic circuit including a controller, a secured basic input/output (BIOS) system, a memory unit, a radio unit, and an antenna, the radio unit and the antenna generating periodic transmissions; and
a network comprising a blockchain;
wherein the electronic circuit counts the periodic transmissions and creates a digital coin when a pre-determined number of transmissions is generated; and
wherein transmission data corresponding to the digital coin are encrypted and stored in the blockchain.

9. The system of claim 8 wherein the at least one communication device comprises multiple communication devices corresponding to multiple users.

10. The system of claim 9 wherein each user can use one or more digital coins to purchase goods or services or to exchange with another currency.

11. The system of claim 9 wherein each user can use one or more digital coins to transfer any monetary value.

12. The system of claim 8 wherein the blockchain is distributed across the network.

13. The system of claim 8 wherein the transmission data is updated and when a second pre-determined number of transmissions is generated a second digital coin is generated.

14. The system of claim 8 wherein the transmission data is sliced into segments and stored in the network database blockchain.

15. The system of claim further comprising a reconstruction key stored on the communication device, the reconstruction key capable of unencrypting the transmission data.

16. A method of converting electronic transmissions into digital currency, comprising:
generating periodic transmissions from a communication device;
counting the periodic transmissions;
creating a digital coin when a pre-determined number of periodic transmissions is generated; and
encrypting transmission data corresponding to the digital coin and storing the transmission data in a blockchain.

17. The method of claim 16 further comprising distributing the blockchain is across a network.

18. The method of claim 16 further comprising updating the transmission data and creating a second digital coin when a second pre-determined number of transmissions is generated.

19. The method of claim 16/17 further comprising slicing the transmission data into segments and storing it in the network database blockchain.

20. The method of claim 16 further comprising calculating a geographical location of the communication device.
